(19) United States
(12) Patent Application Publication
(10) Pub. No.: US 2019/0286718 A1
(43) Pub. Date: Sep. 19, 2019

(54) DATA STRUCTURE WITH ROTATING BLOOM FILTERS

(71) Applicant: QUALCOMM Incorporated, San Diego, CA (US)

(72) Inventors: Jason Norman, Cary, NC (US); Sadayan Ghows Ghani Sadayan Ebramsah Mo Abdul, Morrisville, NC (US)

(21) Appl. No.: 15/922,854

(22) Filed: Mar. 15, 2018

(51) Int. Cl. G06F 17/30

(52) U.S. Cl. CPC G06F 17/30097

(57) ABSTRACT

A method is provided that includes obtaining a data structure that includes a plurality of bloom filters, each including an array of bits and each associated with a plurality of hash functions that map at least one element of a data set to at least one of the bits of the array. An element of the data set is added to the data structure by determining a currently selected bloom filter, applying the element to each of the associated hash functions to obtain a corresponding plurality of array bit positions, and setting bits of the array of the currently selected bloom filter at each of the plurality of array bit positions to a first logic state. The method also includes rotating the plurality of bloom filters based on a number of bits that are set to the first logic state in the array of the currently selected bloom filter.

### FIELD OF DISCLOSURE

The disclosure pertains to data structures that utilize bloom filters and, more particularly, to data structures that utilize rotating bloom filters.

### BACKGROUND

A bloom filter (BF) is a space-efficient probabilistic data structure that is used to test whether an element is a member of a set, and is described in B. Bloom, “Space/Time Tradeoffs in Hash Coding with Allowable Errors,” Communications of the ACM 13:7, pp. 422-426 (1970). The bloom filter is a succinct representation of a set of data, where the bloom filter data structure is more efficient to operate on and/or electronically transmit than the data set which it represents. An empty bloom filter is a bit array of m bits, all set to zero (0). For the filter, there are k different hash functions defined, each of which maps or hashes some set element to one of the array bit positions with a uniform random distribution. To add an element, the element is fed to each of the k hash functions to get k array bit positions. The bits at all of these positions are set to one (1). To query for an element (test whether it is in the set), a candidate element is fed to each of the k hash functions to get k array bit positions. If any of the bits at these positions are 0, the candidate element is definitely not in the set—if it were, then all the bits would have been set to 1 when it was inserted. If all are 1, then either the candidate element is in the set, or the bits have by chance been set to 1 during the insertion of other elements, resulting in a false positive. For certain data applications in which the bloom filter is used, a false positive can be tolerated when compared with the operation and transmission efficiencies that flow from its use.

However, traditional BFs are not meant for an infinite stream of data items since the false positive error rate will eventually approach 100% and never go down. A stable Bloom Filter, using a decrementing integer time value for each array bit position, is one way to keep only a recent history of fills. This, however, uses many times more flops than a simple BF, (e.g., H*m where H is the number of items of history you want to track and m is the number of bits in the array). The above-identified benefits of a BF, however, are only obtained when the predictions are correct. When a prediction is incorrect, costs are incurred.

### SUMMARY

Accordingly, aspects of the present disclosure include a method, a computing device, and a non-transitory computer-readable medium for implementing and utilizing a data structure that includes multiple bloom filters for providing an efficient indication of whether an element is included in a data set. As mentioned above, conventional bloom filters are not meant for an infinite stream of data items since the false positive error rate will eventually increase to levels that reduce or eliminate the benefit of using the bloom filter itself. Thus, aspects of the present disclosure include a data structure that includes multiple bloom filters and a rotation policy for selectively cycling among the multiple bloom filters for filing data into the data structure. In one aspect, the decision of when to rotate the bloom filters may be based on the number of bits that are set in the array of a currently selected bloom filter of the data structure. That is, rather than adding additional components (e.g., flops) to the data structure to count time, or to receive feedback from space filled in the data set, aspects of the present disclosure use the existing bloom filter structure to determine whether rotation is needed and/or to determine when to clear the bloom filters. As will be described in further detail below, the number of bits set in the bloom filters may indirectly correspond to the number of entries that have been filled in the data structure and may also directly indicate the false positive error rate. Thus, aspects of the present disclosure may utilize the number of set bits in the bloom filter data structure to determine when to rotate the bloom filters in order to maintain a desired history of stored data elements. Furthermore, the number of set bits may also be utilized to determine when to clear the bloom filter data structure to maintain an acceptable false positive error rate.

For example, according to one aspect, a method includes obtaining, by a processor, a data structure that includes a plurality of bloom filters. Each bloom filter of the plurality of bloom filters includes an array of bits and is associated with a plurality of hash functions, where each hash function of the plurality of hash functions maps at least one element of a data set to at least one of the bits of the array. The method also includes adding, by the processor, an element of the data set to the data structure, where adding the element to the data structure includes: (i) determining a currently selected bloom filter of the plurality of bloom filters, (ii) applying the element of the data set to each of the plurality of hash functions of the currently selected bloom filter to obtain a corresponding plurality of array bit positions of the array of the currently selected bloom filter, and (iii) setting bits of the array of the currently selected bloom filter at each of the plurality of array bit positions to a first logic state. The processor then rotates the plurality of bloom filters based on a number of bits that are set to the first logic state in the array of the currently selected bloom filter. In one aspect, rotating the plurality of bloom filters includes selecting a next bloom filter of the plurality of bloom filters as the currently selected bloom filter.

In another aspect, a computing device includes at least one processor coupled to at least one memory. The at least one processor and at least one memory are configured to direct the computing device to obtain a data structure that includes a plurality of bloom filters. Each bloom filter of the plurality of bloom filters includes an array of bits and is associated with a plurality of hash functions, where each hash function of the plurality of hash functions maps at least one element of a data set to at least one of the bits of the array. The at least one processor and at least one memory are further configured to direct the computing device to add an element of the data set to the data structure, where adding the element to the data structure includes: (i) determining a currently selected bloom filter of the plurality of bloom filters, (ii) applying the element of the data set to each of the plurality of hash functions of the currently selected bloom filter to obtain a corresponding plurality of array bit positions of the array of the currently selected bloom filter, and (iii) setting each of the plurality of array bit positions to a first logic state. The computing device then rotates the plurality of bloom filters based on a number of bits that are set to the first logic state in the array of the currently selected bloom filter, where rotating the plurality of bloom filters includes selecting a next bloom filter of the plurality of bloom filters as the currently selected bloom filter.

In a further aspect, a computing device includes means for obtaining a data structure that includes a plurality of bloom filters. Each bloom filter of the plurality of bloom filters includes an array of bits and is associated with a plurality of hash functions, where each hash function of the plurality of hash functions maps at least one element of a data set to at least one of the bits of the array. The computing device also includes means for adding an element of the data set to the data structure, where the means for adding the element to the data structure includes: (i) means for determining a currently selected bloom filter of the plurality of bloom filters, (ii) means for applying the element of the data set to each of the plurality of hash functions of the currently selected bloom filter to obtain a corresponding plurality of array bit positions of the array of the currently selected bloom filter, and (iii) means for setting each of the plurality of array bit positions to a first logic state. Further included in the computing device is a means for rotating the plurality of bloom filters based on a number of bits that are set to the first logic state in the array of the currently selected bloom filter, where the means for rotating the plurality of bloom filters includes means for selecting a next bloom filter of the plurality of bloom filters as the currently selected bloom filter.

In yet another aspect, a non-transitory computer-readable medium including program code is provided. The program code includes instructions, which when executed by a processor of a computing device, directs the computing device to obtain a data structure that includes a plurality of bloom filters. Each bloom filter of the plurality of bloom filters includes an array of bits and is associated with a plurality of hash functions, where each hash function of the plurality of hash functions maps at least one element of a data set to at least one of the bits of the array. The instructions further direct the computing device to add an element of the data set to the data structure, where adding the element to the data structure includes: (i) determining a currently selected bloom filter of the plurality of bloom filters, (ii) applying the element of the data set to each of the plurality of hash functions of the currently selected bloom filter to obtain a corresponding plurality of array bit positions of the array of the currently selected bloom filter, and (iii) setting each of the plurality of array bit positions to a first logic state. The program code also includes instructions to direct the computing device to rotate the plurality of bloom filters based on a number of bits that are set to the first logic state in the array of the currently selected bloom filter, where the instructions to rotate the plurality of bloom filters includes instructions to select a next bloom filter of the plurality of bloom filters as the currently selected bloom filter.

### BRIEF DESCRIPTION OF THE DRAWINGS

The accompanying drawings are presented to aid in the description of aspects, and exemplary practices according to the aspects, and are provided solely for illustration of the embodiments and not limitation thereof.

FIG. 1 is a flow chart illustrating a process of utilizing a data structure that includes a plurality of bloom filters, according to various aspects.

FIG. 2 is a graphical illustration that shows an example data structure that includes a plurality of bloom filters, in accordance with various aspects.

FIG. 3 is a diagram illustrating a process of adding an element of a data set to a data structure, according to various aspects.

FIG. 4 is a flow chart illustrating a process of rotating a plurality of bloom filters of a data structure based on a number of bits of an array of the currently selected bloom filter that are set to a first logic state, according to various aspects.

FIG. 5 is a flow chart illustrating a process of rotating a plurality of bloom filters of a data structure based on an estimated number of elements in a currently selected bloom filter, according to various aspects.

FIG. 6 is a diagram illustrating the filling and rotating of an example data structure, according to various aspects.

FIG. 7 is a function block diagram illustrating an example memory management unit that incorporates a bloom filter data structure, according to various aspects.

FIG. 8 is a flow chart illustrating a process of utilizing a bloom filter data structure to predict whether a translation lookaside buffer (TLB) entry exists in a TLB of a processor, according to various aspects.

FIG. 9 is a functional block diagram illustrating a computing device, according to various aspects.

FIG. 10 illustrates several sample aspects of components that may be employed in a computing device, according to various aspects.

### DETAILED DESCRIPTION

Example devices, methods, system and operations according to various aspects are disclosed in the following description and related drawings. Alternatives may be devised without departing from disclosed concepts. Additionally, well-known elements will not be described in detail or will be omitted so as not to obscure the relevant details of the invention.

The word “exemplary” is used herein to mean “serving as an example, instance, or illustration.” Any implementation or variation described herein as “exemplary” is not necessarily to be construed as preferred or advantageous over other implementations and variations therefore.

The terminology used herein is for the purpose of describing particular implementations and operations only and is not intended to be limiting of any aspect. As used herein, the singular forms “a”, “an” and “the” are intended to include the plural forms as well, unless the context clearly indicates otherwise. It will be understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, methods and processes according to various aspects may be described, at least in part, in terms of sequences of actions performed by, for example, a particularly configured computing device, or portions of one or more of such devices. It will be recognized that various actions described herein can be performed by specific circuits (e.g., application specific integrated circuits (ASICs)), by program instructions being executed by one or more processors, or by a combination of both. Additionally, sequences of actions described herein can be considered to be embodied entirely within any form of computer-readable storage medium having stored therein a corresponding set of computer instructions that upon execution would cause an associated processor to perform the functionality described herein. Thus, the various aspects may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

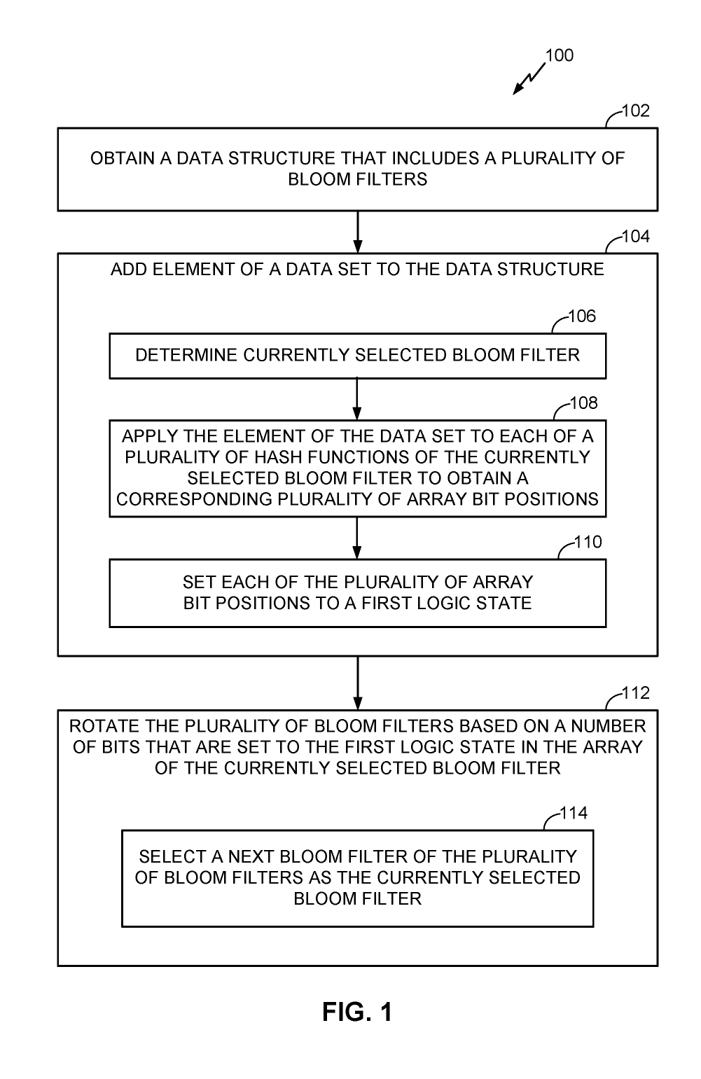

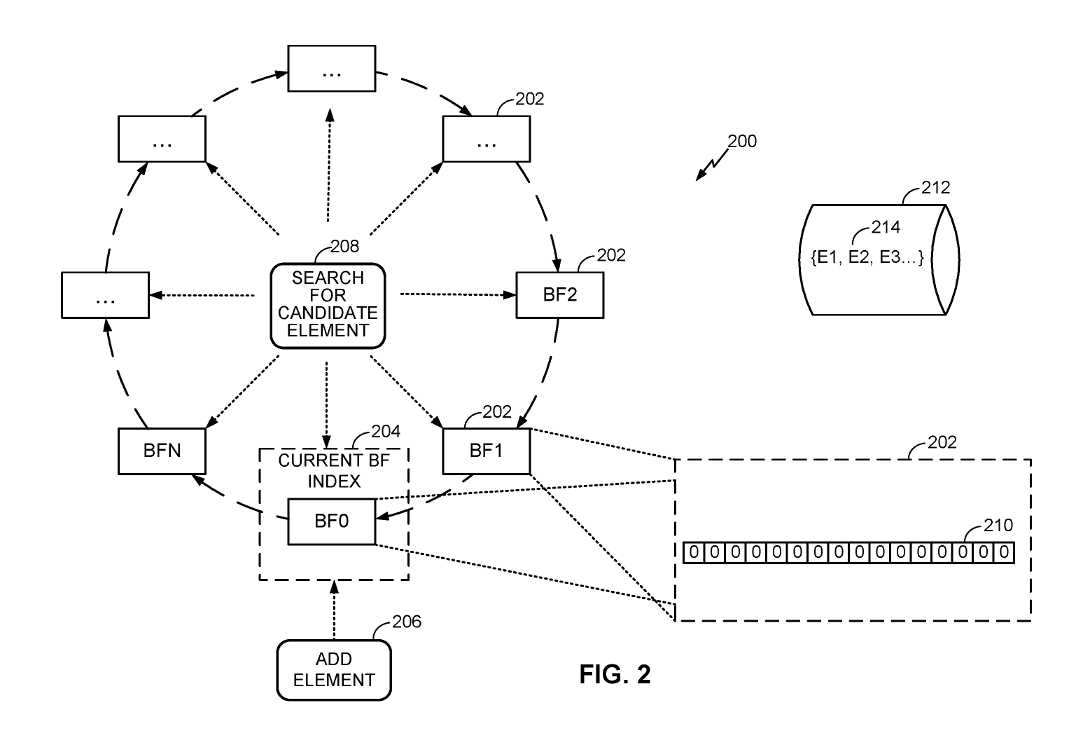

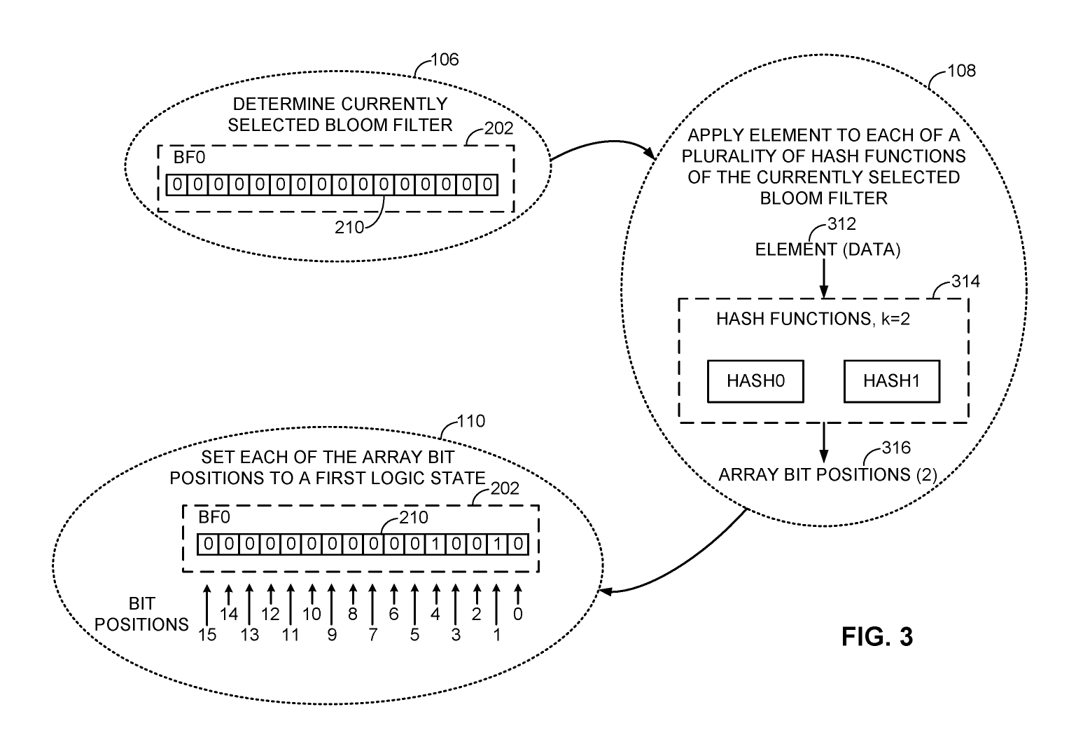

FIG. 1 is a flow chart illustrating a process 100 of utilizing a data structure that includes a plurality of bloom filters, according to various aspects. Process 100 will be described with additional reference to FIGS. 2 and 3. For example, FIG. 2 illustrates an example data structure 200 that includes a plurality of bloom filters 202, in accordance with various aspects. As shown in FIG. 2, each bloom filter 202 includes an array 210 of bits. Although FIG. 2 illustrates data structure 200 as including n number of bloom filters (e.g., BF0-BFN), any number of bloom filters may be included in the data structure 200, including 2 or more. FIG. 2 also illustrates a data set 212 that includes one or more data elements 214. In operation, data structure 200 may be used to determine whether a candidate element is a member of data set 212.

As will be described in more detail below, operation of the data structure 200 may include maintaining an index 204 that refers to a currently selected bloom filter. As shown in the example of FIG. 2, bloom filter BF0 is the currently selected bloom filter as indicated by index 204, where when elements (i.e., data elements 214 of a data set 212) are added to the data structure 200, the currently selected bloom filter (e.g., BF0) is the only bloom filter 202 to be filed, as indicated by procedure 206. That is, when an element of a data set is to be added to the data structure 200, the element is added only to the currently selected bloom filter. However, when the data structure 200 is to be searched, all bloom filters will be used. For example, procedure 208 illustrates that when data structure 200 is searched to determine whether a candidate element is in a data set, all bloom filters 202 are searched. In one example, when data structure 200 is searched, all bloom filters 202 are searched as a bitwise OR of all bloom filters 202 (i.e., BF0-BFN). Thus, in this example, a candidate element may be determined to be in a data set if any of the bloom filters 202 indicate that the candidate element is in the data set.

Returning now to FIG. 1, process block 102 includes obtaining, by a processor, a data structure that includes a plurality of bloom filters, such as data structure 200 of FIG. 2. If the data structure 200 is implemented as a software module, obtaining the data structure 200 may include allocating, initializing, and/or retrieving the data structure 200 from memory of a computing device. If the data structure 200 is implemented as one or more digital circuits, obtaining the data structure 200 may include activating or otherwise accessing the digital circuits.

Process block 104 includes the processor adding an element of a data set to data structure 200. In one example process block 104 corresponds to procedure 206 of FIG. 2, which is illustrated in detail in FIG. 3. Referring now to FIG. 3, process block 106 includes determining a currently selected bloom filter of the plurality of bloom filters of the data structure 200. For example, determining the currently selected bloom filter may include reading the index 204 to determine which one of the plurality of bloom filters 202 is the currently selected bloom filter (e.g., bloom filter BF0 is the currently selected bloom filter in FIG. 2).

Next, in process block 108, the processor applies the element 312 of the data set to each of a plurality of hash functions 314 that are associated with the currently selected bloom filter. Although FIG. 3 illustrates only two (i.e., k=2) hash functions, any number of hash functions may be associated with the currently selected bloom filter, including one or more. In one example, each hash function 314 includes any function that can be used to map data of arbitrary size to data of fixed size. For example, each hash function 314 may be configured to map or hash the element 312 to one of several array bit positions 316 of the currently selected bloom filter. In one aspect, the mapping or hashing of elements of a data set are hashed to the bit positions of array 210 with a uniform random distribution. In one example, the same hash functions 314 are utilized for each bloom filter. That is, when bloom filter BF0 is the currently selected bloom filter, hash functions HASHO and HASH1 are used for adding elements to the data structure 200, whereas when bloom filter BF1 is the currently selected bloom filter, the same hash functions HASHO and HASH1 may be also utilized.

As shown in FIG. 3, applying the element 312 to each of the plurality of hash functions 314 results in obtaining a corresponding plurality of array bit positions 316. That is, the number of array bit positions obtained is equal to the number k of hash functions included in the plurality of hash functions 314. In the example of FIG. 3, k is equal to two, and thus applying the element 312 to the hash functions 314 results in obtaining two array bit positions 316.

Next, in process block 110, the processor sets bits of the array 210 of the currently selected bloom filter 202 (e.g., BF0) to a first logic state (e.g., logic “1”) at each of the array bit positions 316. In the example of FIG. 3, the bits at bit positions 1 and 4 are set to the first logic state in response to the array bit positions 316 obtained in process block 108.

As shown, process blocks 106, 108, and 110 illustrate an example operation of adding an element to a bloom filter. As will be described in further detail below, additional operations may be performed on the data structure, such as rotating, clearing, and searching. With regards to searching the data structure 200, searching may entail searching each bloom filter 202 of the data structure 200 for a candidate element. If any of the bloom filters indicate that the candidate element is in the data set 212 then it is determined that the candidate element is indeed in the data set 212. Similarly, if all of the bloom filters indicate that the candidate element is not in the data set 212 then it is determined that the candidate element is not included in the data set 212. When searching the data structure 200 for a candidate element, a similar process to that illustrated in process block 108 of FIG. 3 may be employed for searching each bloom filter. For example, searching for a candidate element may include applying the candidate element to each of a plurality of hash functions 314 to obtain a corresponding plurality of array bit positions 316. A bloom filter is determined to have stored the candidate element only if all the bits at the array bit positions 316 are set to the first logic state. If any of the array bit positions 316 are not set to the first logic state (i.e., instead set to the second logic state), then the candidate element is determined to not have been stored in the bloom filter.

Returning now to FIG. 1, process 100 further includes rotating the plurality of bloom filters (i.e., process block 112). In one aspect, rotating the plurality of bloom filters includes selecting a next bloom filter of the plurality of bloom filters as the currently selected bloom filter (i.e., process block 114). For example, referring to FIG. 2, index 204 indicates that bloom filter BF0 is the currently selected bloom filter. Thus, rotating the bloom filters may include incrementing the index 204 such that bloom filter BF1 is now the currently selected bloom filter. In one aspect, rotating the plurality of bloom filters includes clearing the next bloom filter before selecting it as the currently selected bloom filter. Thus, in the example of FIG. 2, bloom filter BF1 may be cleared (e.g., all bits of array 210 reset to a logic “0”) when bloom filter BF1 is selected as the currently selected bloom filter.

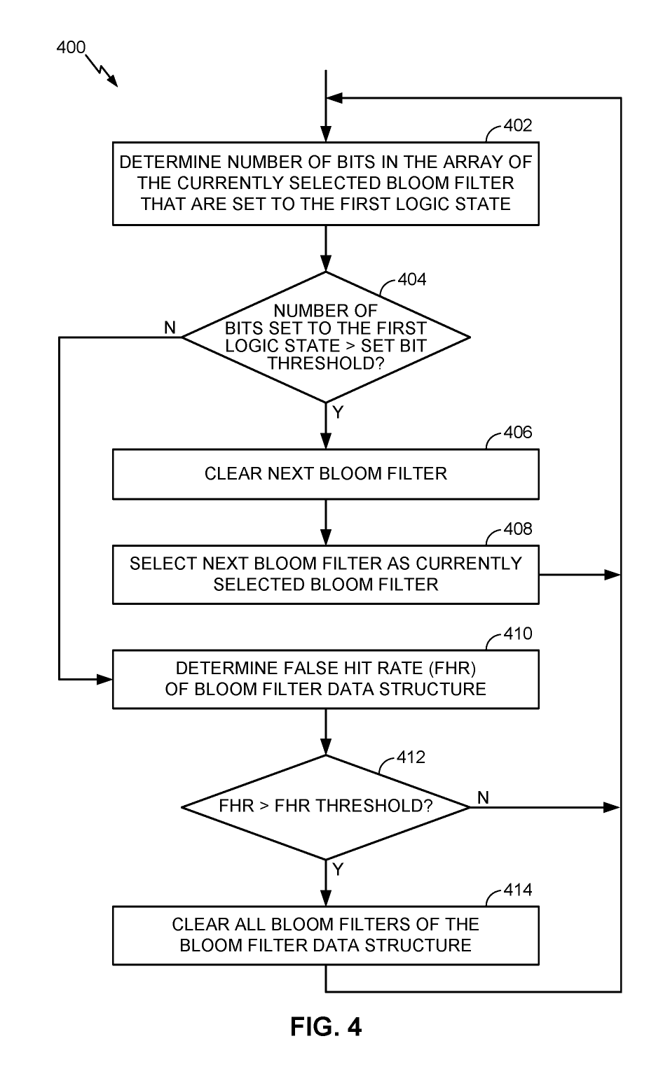

As mentioned above, the number of bits set in the array of a bloom filter may indirectly correspond to the number of elements that have been added to that bloom filter. Accordingly, the process of rotating the bloom filters may be based on the number of bits of the array of the currently selected bloom filter that are set to the first logic state (e.g., logic “1”). For example, FIG. 4 is a flow chart illustrating a process 400 of rotating a plurality of bloom filters of a data structure based on a number of bits of an array of the currently selected bloom filter that are set to a first logic state, according to various aspects. Process 400 is one possible implementation of process block 112 of FIG. 1.

Process block 402 includes determining the number of bits in the array of the currently selected bloom filter that are set to the first logic state. By way of example, FIG. 3 illustrates that array 210 of bloom filter BF0 has two bits (i.e., bits 1 and 4) set to the first logic state. Next, in decision block 404, a determination is made whether the number of bits set to the first logic state is greater than a set bit threshold. In one example, the value of the set bit threshold is set to control a desired history of the data structure 200. That is, the value of the set bit threshold may, at least, partially control how many items are stored in each bloom filter before rotation. In one example, the set bit threshold is set to 50% of the total number of bits in the array of the currently selected bloom filter. Thus, in the example of FIG. 3, which illustrates an array 210 having 16 bits, the set bit threshold may be set to 8.

Next, in process block 406, the next bloom filter is cleared in response to determining that the set bit threshold has been exceeded by the currently selected threshold. In process block 408, the next bloom filter is selected as the currently selected bloom filter. For example, referring to FIG. 2, once the number of bits of array 210 of bloom filter BF0 exceeds the set bit threshold, bloom filter BF1 may be cleared and selected as the currently selected bloom filter (e.g., by incrementing index 204). In one aspect, the determination as to whether to rotate the bloom filters is made each time an element is added to the data structure 200.

As mentioned above, the number of bits set in the bloom filters may directly indicate the false positive error rate (also referred to herein as the false hit rate). Thus, in process block 410 the false hit rate (FHR) of the data structure 200 is determined. In one example, determining the FHR includes determining the total of all bits of all the bloom filters 202 that are set to the first logic state (e.g., logic “1”). For example, the FHR hit rate may be determined based on the sum of all bits of all arrays 210 of each bloom filter BF0-BFN that are set to the first logic state. In decision block 412, a determination is made as to whether the FHR exceeds a FHR threshold. In one aspect, the FHR threshold may be equal to 25% of the total number of bits. Thus, if the total number of bits of all the arrays 210 of all the bloom filters 202 that are set to the first logic state exceeds the FHR threshold, process 400 proceeds to process block 414, where all bloom filters 202 are cleared. In one example, clearing all the bloom filters 202 includes resetting all bits of each array 210 of each bloom filter 202 to a second logic state (e.g., logic “0”). In one aspect, the determination as to whether to clear all the bloom filters is made each time an element is added to the data structure 200.

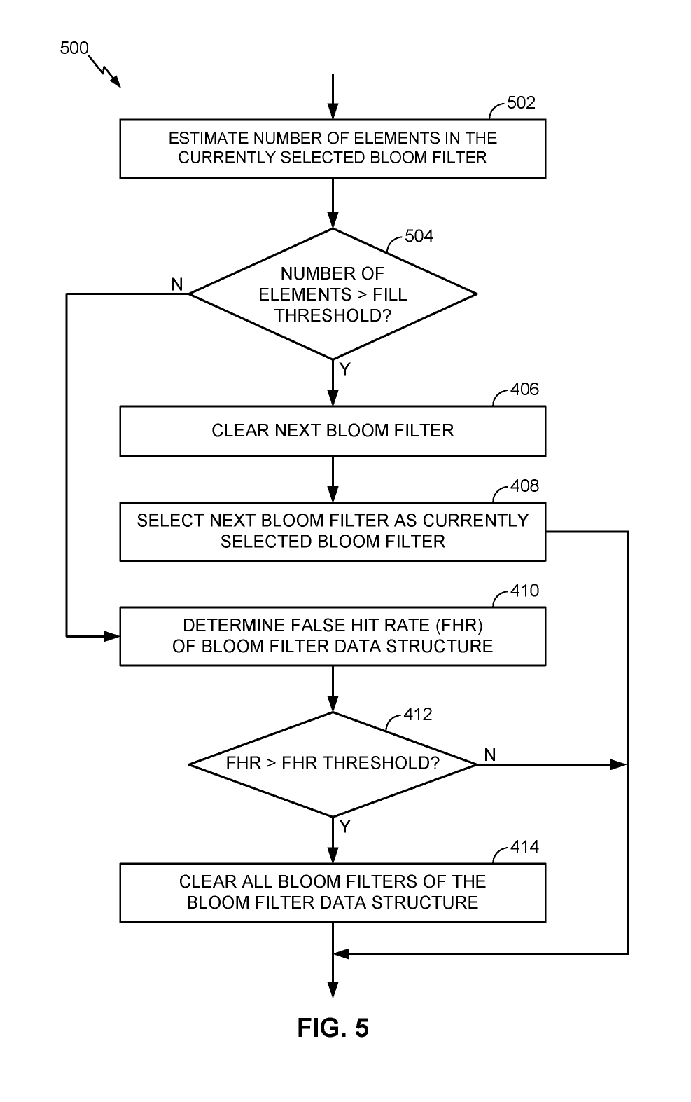

As described above, process 400 includes rotating the bloom filters based directly on the number of bits of the array 210 of the currently selected bloom filter that are set to the first logic state. In another example, the determination of whether to rotate may be based on an estimate of the number of elements actually stored in the currently selected bloom filter. For example, FIG. 5 is a flow chart illustrating a process 500 of rotating the bloom filters of data structure 200 based on an estimated number of elements in the currently selected bloom filter, according to various aspects. Process 500 is one possible implementation of process block 112 of FIG. 1.

In process block 502, an estimate is made of the number of elements in the currently selected bloom filter. In one example, the estimate of the number of elements may be based, in part, on the number of bits on the array 210 of the currently selected bloom filter that are set to the first logic state. For example, aspects of process block 502 may include estimating the number of elements stored in the currently selected bloom filter based on a total number of bits in the array of the currently selected bloom filter (e.g., 16 total bits in array 210 of FIG. 3), a number of the hash functions associated with the currently selected bloom filter (e.g., k=2 in hash functions 314 of FIG. 3), and the number of bits that are set to the first logic state in the array of the currently selected bloom filter (e.g., 2 bits are set to the first logic state in array 210 as shown in the bottom of FIG. 3). In particular, estimating the number of elements stored in the currently selected bloom filter may be based on:

$$E = - \frac{m}{k} ln [ 1 - \frac{\# of Set Bits}{m} ] , \qquad EQ . 1$$

where E is the number of elements stored in the currently selected bloom filter, m is the total number of the bits in the array of the currently selected bloom filter, k is the number of the hash functions associated with the currently selected bloom filter, and # of Set Bits is the number of bits that are set to the first logic state in the array of the currently selected bloom filter.

Thus, in some examples, the number of elements stored in the currently selected bloom filter may be determined based on equation 1, where in decision block 504 of FIG. 5, a determination is made as to whether the number of estimated elements is greater than a fill threshold. If so, process proceeds to process blocks 406 and 408 to clear a next bloom filter and select the next bloom filter as the currently selected bloom filter.

In one example, a value of the fill threshold is based on a maximum desired history of the data structure 200 as well as the number of bloom filters 202 that are included in the data structure 200. In particular, the fill threshold may be based on a ratio n/N, where n is the maximum history and N is the number of bloom filters. For example, assuming that the number of bloom filters is N=2, and a maximum history is n=256, then rotation would occur when the estimated number of elements stored in the currently selected bloom filter exceeds 128 (i.e., 256/2). Similarly, assuming that the number of bloom filter is N=4, and the maximum history is 256, then rotation would occur when the estimated number of elements stored in the currently selected bloom filter exceeds 64 (i.e., 256/4).

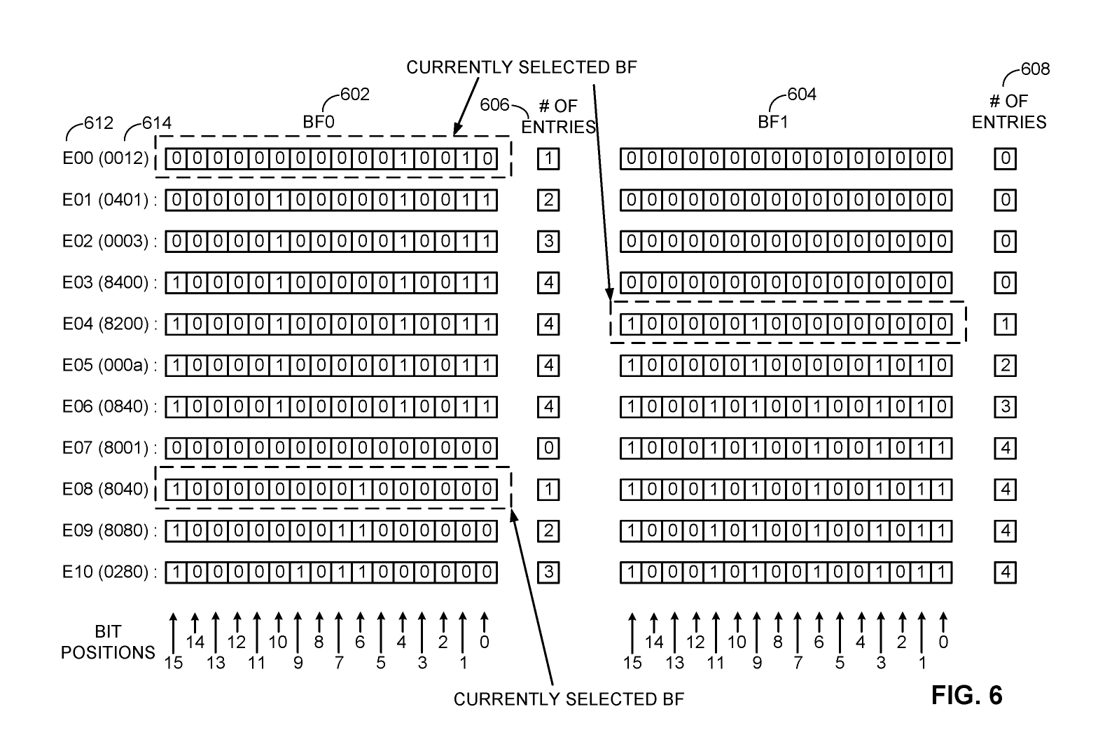

FIG. 6 is a diagram illustrating the filling and rotating of an example data structure, according to various aspects. The data structure of FIG. 6 includes a bloom filter BF0 602 and bloom filter BF1 604 as well as their corresponding arrays. The data structure of FIG. 6 includes two corresponding hash functions (i.e., k=2, not shown in FIG. 6) and is one possible implementation of data structure 200 of FIG. 2. FIG. 6 also illustrates a column 606 which indicates the number of entries added to bloom filter BF0 602 as well as a column 608 which indicates the number of entries added to bloom filter BF1 604. Further shown in FIG. 6 are several elements 612 (e.g., E00-E10) of a data set (e.g., data set 212 of FIG. 2) as well as their corresponding data values 614.

As shown in FIG. 6, when element E00 is added to the data structure, bloom filter BF0 602 is the currently selected bloom filter of the data structure. Element E00's data value 614 (e.g., 0012) is then applied to each of the k=2 hash functions to obtain array bit positions 1 and 4. Thus, as shown in FIG. 6, the bits of the array of bloom filter BF0 602 are set to a logic “1” at both bit positions 1 and 4. Element E01 is similarly added to the currently selected bloom filter BF0 602 where bit positions 0 and 10 are both set to a logic “1”. Next, with bloom filter BF0 602 still set as the currently selected bloom filter, element E02 is added to the data structure. However, the result of applying the data value (i.e., 0003) of element E02 to the hash functions results in duplicate array bit positions (e.g., bit positions 0 and 1). Thus, since bit positions 0 and 1 are already set to a logic “1”, the bits at these positions are allowed to remain set to the logic “1”. Similarly, when element E03 is added, application of the data value 8400 to the hash functions results in one new bit position (i.e., bit position 15) and one duplicate bit position (e.g., bit position 10). Thus, bit position 15 of bloom filter BF0 602 is set to logic “1” and bit position 10 remains set to the logic “1”.

After entry of element E03, the total number of entries stored in the currently selected bloom filter BF0 602 is 4, which is determined to exceed the fill threshold. Thus, as shown, the data structure is rotated by clearing bloom filter BF1 604 (e.g., all bits reset to logic “0”) and setting bloom filter BF1 604 as the currently selected bloom filter. Elements E04-E07 are then added to bloom filter BF1 604 in a similar manner as described above with reference to bloom filter BF0 602. As can be seen, while elements are added to bloom filter BF1 604, bloom filter BF0 602 maintains a history of recent elements that have been added to the data structure. Thus, a search of the data structure would include a search of both the currently selected bloom filter BF1 604 as well as the bloom filter BF0 602.

However, after entry of the element E07, the fill threshold for the currently selected bloom filter (i.e., BF1 604) has been exceeded. Thus, the data structure is again rotated such that bloom filter BF0 602 is now cleared and set as the currently selected bloom filter.

The above-described data structures and associated operations of adding elements, rotating the data structure, clearing one or more bloom filters, and searching for candidate elements may be applicable to any data streaming application where recognizing recent repeats is desired. Generally speaking, aspects of the present disclosure might apply well to any hardware requiring data set hints in an ultra low-latency and small footprint design. For example, aspects of the present disclosure, including the aforementioned data structures, may be implemented in conjunction with a translation-lookaside buffer (TLB) of a memory management unit (MMU), where the data structure may be utilized to indicate whether a certain transaction has been seen before, which (minus invalidations) is directly correlated to a TLBs contents.

In general, MMUs are commonly used in microprocessors to provide virtual memory capability. When virtual memory is enabled, software executing on the processor only sees and uses Virtual Addresses (VA). The MMU is tasked to convert a VA into a Physical Address (PA) that can then be used inside and outside the processor. Using virtual memory has a number of advantages including being able to give the illusion of more memory than is actually available, giving access to a physical memory system that has more address bits than are supported by the software, and protection of the physical memory with varying access rights.

In general, the virtual address space is divided into pages. Pages are commonly a few kilobytes, though other page sizes can be used. Systems often support multiple page sizes from a few kilobytes to a few megabytes or even gigabytes to increase translation efficiency. All addresses within a page are translated in the same fashion and all the access right information is the same. The translation between VAs and PAs is done through a (often multi-level) page table. The process of going through the page table to translate a VA into a PA is often called walking as it comprises a sequence of table lookups.

The MMU often comprises two parts. The first part is the TLB. It caches translations so that they are very quickly accessible to the processor, so that for translations that are cached, the processor can execute with little delay. The second part is the walker, which walks the page tables when the TLB does not contain a translation. In some systems, there may be more caching between the TLB and the walker. For instance, the TLB may have 2 levels of caching. The walker may itself contain a cache.

Similar translations to the same page (such as those initiated from a DMA engine) can be stacked behind each other to better utilize memory translation resources. That way, when the first translation is done with its long memory translation, subsequent similar translations will all be fast TLB hits. This avoids wasting translation resources with all resources translating the same page.

However, if the first translation is already cached locally in the TLB, these translations stacked behind the first one, have all unnecessarily waited several cycles behind the first one, waiting for a TLB result. This can cause dead cycles in giving a translation result for a fully populated TLB.

Accordingly, aspects of the present disclosure may incorporate a data structure, such as data structure 200, into an MMU to determine whether a translation in a line will likely be a TLB hit within a single cycle, rather than wait several cycles (for a full TLB search) before dispatching the similar translations behind it. In one aspect, the data structure 200 may be implemented with the TLB to determine whether a transaction has likely resulted in a TLB hit previously. If so, similar transactions may be dispatched immediately (and not stacked) to reduce latency caused by unnecessary stacking.

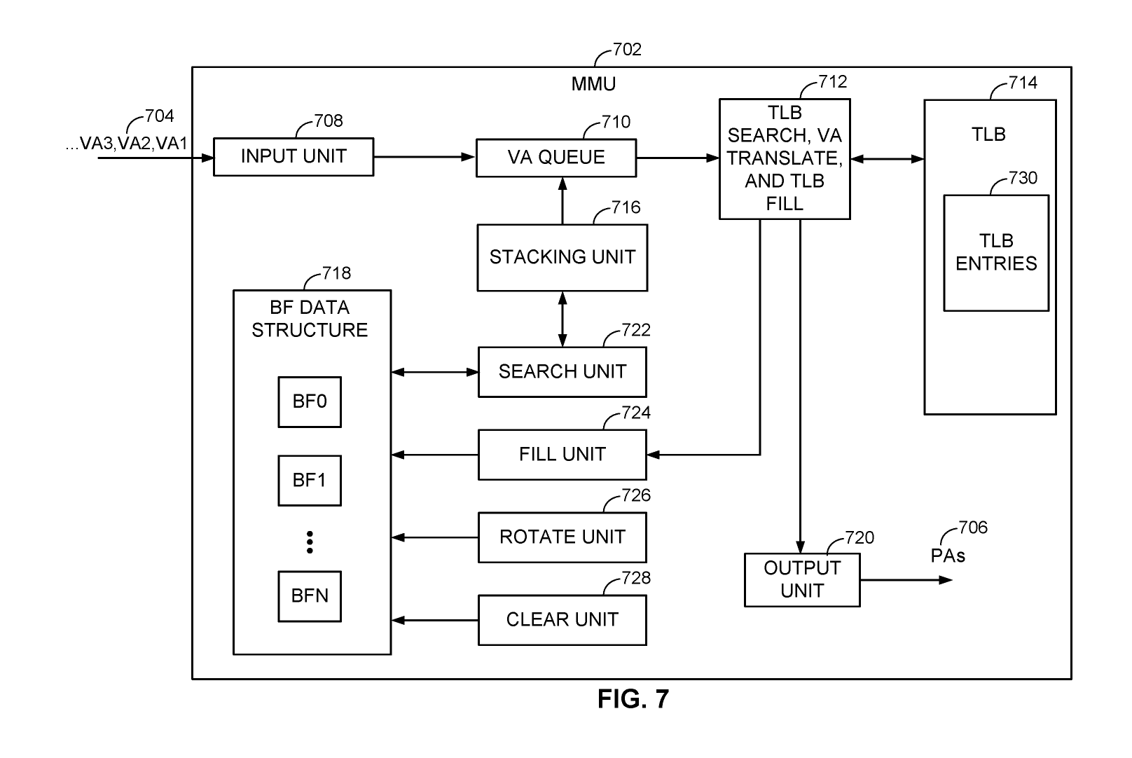

For example, FIG. 7 is a functional block diagram illustrating an example MMU 702 that incorporates a bloom filter (BF) data structure 718, according to various aspects. The illustrated example of MMU 702 includes a input unit 708, a VA queue 710, TLB search, VA translate, and TLB Fill unit 712, TLB 714, a stacking unit 716, the BF data structure 718, output unit 720, search unit 722, fill unit 724, rotate unit 726, and clear unit 728. Included in TLB 714 are one or more TLB entries 730. Also illustrated in FIG. 7 are virtual addresses 704 (e.g., VA1, VA2, and VA3) as well as PAs 706.

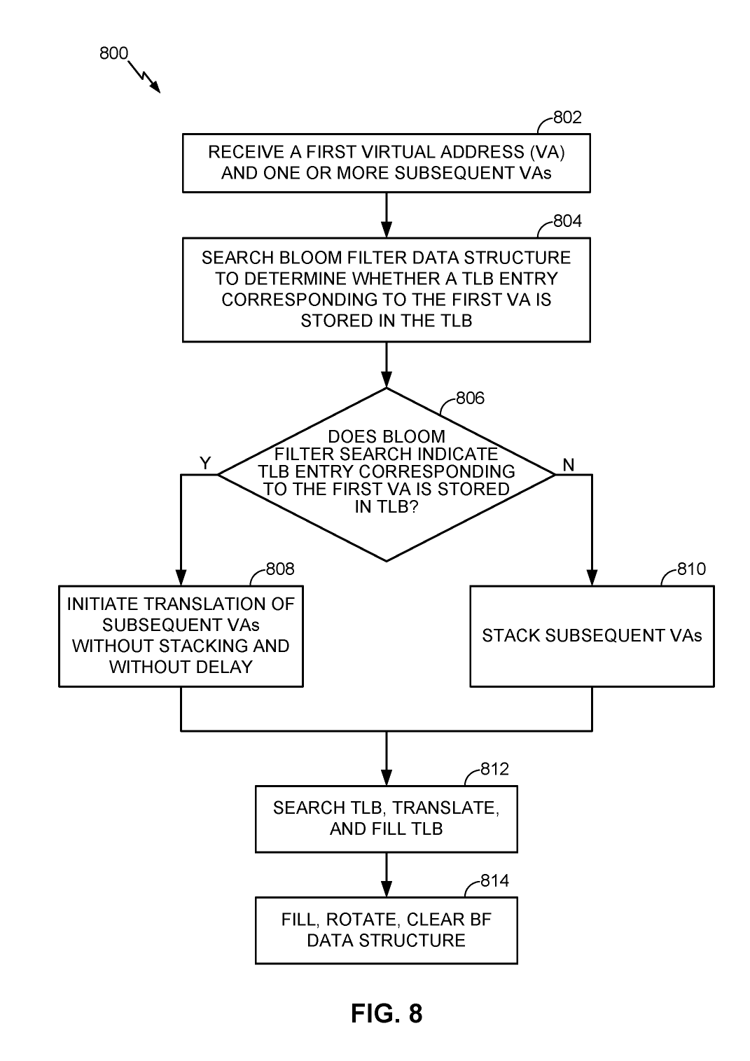

In one example, BF data structure 718 may be implemented as data structure 200 of FIG. 2, where TLB entries 730 correspond to the one or more data elements 214 of data set 212. The operation of MMU 702 will be described with additional reference to FIG. 8, which illustrates an example process 800 of utilizing BF data structure 718 to predict whether a TLB entry exists in the TLB entries 730 of TLB 714.

For example, in a process block 802, the input unit 708 of MMU 702 receives multiple VAs 704. The VAs 704 may be received at the input unit 708 via one or more VA translation requests generated by a processor or other processing device (e.g., CPU). The VAs 704 may include a first VA (e.g., VA1) as well as one or more subsequent VAs (e.g., VA2 and VA3). The input unit 708 is coupled to provide the VAs 704 to the VA queue 710, which provides scheduling or otherwise organizing of the received VAs 704 for translation. The stacking unit 716 is coupled to the VA queue 710 to determine whether one or more of the received VAs 704 should be stacked. In one aspect, the stacking unit 716 determines whether to stack VAs 704, in part, based upon a determination that a received VA 704 is similar to another VA 704 already in the VA queue 710. For example, stacking unit 716 may determine that subsequent VAs, VA2 and VA3, are similar to the first VA1 if the stacking unit 716 determines that they are included in the same page of virtual address space (i.e., VA2 and VA3 are similar to VA1 if VA2 and VA3 are in the same page of virtual address space as VA1).

In one aspect, stacking similar transactions includes delaying the translation of the subsequent VAs until a translation of the first VA is complete and until an entry corresponding to the first VA has been stored in the TLB 714. Thus, when translation of the first VA is done, translations of subsequent similar VAs translations will all be fast TLB hits. However, as mentioned above, if an entry corresponding to the first VA is already cached locally in the TLB 714, stacking similar VAs (i.e., VA2 and VA3) behind the first VA1, will result in the unnecessary delay of translation of the subsequent VAs. Accordingly, stacking unit 716 may utilize BF data structure 718 to determine whether a translation of the first VA will likely result in a TLB hit in order to determine whether to stack the subsequent VAs.

In particular, process block 804 includes the search unit 722 searching the BF data structure 718 to determine whether a TLB entry (e.g., TLB entries 730) corresponding to the first VA1 is stored in the TLB 714. By way of example, searching the BF data structure 718 may include searching all the bloom filters BF0-BFN of BF data structure 718 to determine whether an entry corresponding to the first VA1 is already stored in the TLB 714. In one aspect, all bloom filters BF0-BFN are searched as a bitwise OR of all bloom filters. Thus, in this example, a TLB entry corresponding to the first VA may be determined to be stored in the TLB 714 if any of the bloom filters of BF data structure 718 indicate that the entry corresponding to the first VA1 is in the TLB 714.

When searching the BF data structure 718 for a candidate element (e.g., the first VA1), a similar process to that illustrated in process block 108 of FIG. 3 may be employed for searching each bloom filter. For example, searching for the first VA1 may include applying all or a portion of the value of the first VA1 to each of a plurality of hash functions 314 to obtain a corresponding plurality of array bit positions 316. A bloom filter is determined to have stored the first VA1 only if all the bits at the array bit positions 316 are set to the first logic state (e.g., see FIG. 3). If any of the array bit positions 316 are not set to the first logic state (i.e., instead set to the second logic state), then the first VA1 is determined to not have been stored in that bloom filter.

Returning now to FIG. 8, upon decision block 806 determining that there is no TLB entry corresponding to the first VA1 stored in the TLB 714, process 800 proceeds to process block 810 where stacking unit 716 stacks the subsequent VAs (VA2 and VA3). As mentioned above, stacking the subsequent VAs includes delaying translation of the subsequent VAs until translation of the first VA1 is complete and until a TLB entry corresponding to the first VA1 has been stored in the TLB 714.

If however, a search of the BF data structure 718 reveals that there is indeed a TLB entry corresponding to the first VA1 already stored in the TLB 714, then process 800 proceeds to process block 808, where stacking unit 716 determines to not stack the subsequent VAs. In one example, the determination to not stack the subsequent VAs includes initiating translation of the subsequent VAs immediately and without the delay that would be incurred by stacking.

As shown in FIG. 8, process block 812 includes the search of the TLB 714, the translation of one or more VAs, as well as the filling (i.e., adding) of one or more TLB entries 730 to the TLB 714. In particular, searching the TLB 714 may include searching the TLB entries 730 for a TLB entry corresponding to the first VA1, while the subsequent VAs, VA2 and VA3, are delayed (if stacking unit 716 determines to stack the subsequent VAs). Similarly, searching the TLB 714 may include searching the TLB entries 730 for TLB entries corresponding to the first VA1, while also searching for TLB entries corresponding to the subsequent VAs without the delay (if stacking unit 716 determines to not stack the subsequent VAs). Furthermore, the translation of one or more VAs may include walking the page tables (e.g., by way of a walker included in block 712 of FIG. 7) when the search of the TLB 714 results in a TLB miss (i.e., no entry corresponding to the VA is stored in the TLB). After translation of the VA to PA, the PA 706 is then provided by way of output unit 720.

As mentioned above, translation of a VA 704 to a PA 706 may include adding a corresponding TLB entry 730 to the TLB 714. In addition, aspects of the present disclosure may include updating the BF data structure 718 each time a TLB entry 730 is added to TLB 714. For example, process block 814 includes the filling, rotation, and clearing of the BF data structure 718. In one aspect, filling the BF data structure 718 may include fill unit 724 performing process block 104 of FIG. 1 to add an element (e.g., VA) to the BF data structure 718. In addition, rotating the BF data structure 718 may include rotate unit 726 performing process block 112 of FIG. 1, process 400 of FIG. 4, and/or process 500 of FIG. 5. Furthermore, clearing the BF data structure 718 may include clear unit 728 clearing a next bloom filter when rotating the BF data structure 718 and/or may include clearing all bloom filters of the BF data structure 718 in response to determining that the false hit rate (FHR) exceeds the FHR threshold.

As will be appreciated by those skilled in the art, the various components of MMU 702 including input unit 708, VA queue 710, TLB search, VA translate, and TLB Fill unit 712, TLB 714, a stacking unit 716, the BF data structure 718, output unit 720, search unit 722, fill unit 724, rotate unit 726, and clear unit 728 can be embodied in discrete elements, software modules executed on a processor or any combination of software and hardware to achieve the functionality disclosed herein. For example, any of the illustrated components of MMU 702 may be implemented in hardware (e.g., application specific integrated circuit (ASIC), programmable gate array (PGA), discrete digital circuits, etc.) or in a combination of hardware and software (e.g., a software model executed by a corresponding processor). Alternatively, the functionality of the components of MMU 702 could be incorporated into one discrete component.

Therefore, the features of the MMU 702 of FIG. 7 are to be considered merely illustrative and the invention is not limited to the illustrated features or arrangement.

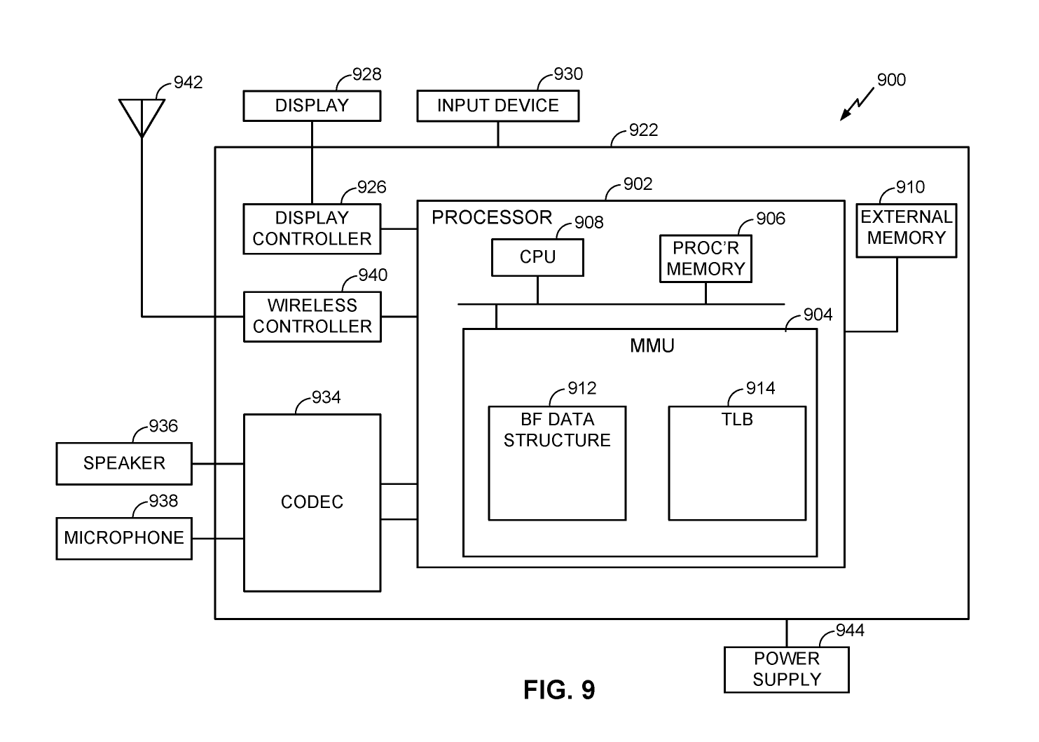

FIG. 9 is a functional block diagram illustrating a computing device 900, according to various aspects. The example computing device 900 is shown in FIG. 9 as including a processor 902 having a CPU 908, a processor memory 906 and a memory management unit (MMU) 904, interconnected by a system bus (visible in FIG. 9, but not separately labeled). In one aspect, the MMU 904 may be configured to include one or more components of MMU 702 of FIG. 7. The MMU 904 also includes BF data structure 912 that may be configured as the data structure 200 of FIG. 2 and a TLB 914 that may be configured as the TLB 714 of FIG. 7.

Computing device 900 may be configured to perform the various methods described in reference to FIGS. 1-8, and may be further be configured to execute instructions retrieved from processor memory 906, or external memory 910 in order to perform any of the methods described in reference to FIGS. 1-8.

FIG. 9 also shows display controller 926 that is coupled to processor 902 and to display 928. Coder/decoder (CODEC) 934 (e.g., an audio and/or voice CODEC) can be coupled to processor 902. Other components, such as wireless controller 940 (which may include a modem) are also illustrated. For example, speaker 936 and microphone 938 can be coupled to CODEC 934. FIG. 9 also indicates that wireless controller 940 can be coupled to wireless antenna 942. In a particular aspect, processor 902, display controller 926, processor memory 906, external memory 910, CODEC 934, and wireless controller 940 may be included in a system-in-package or system-on-chip device 922.

In a particular aspect, input device 930 and power supply 944 can be coupled to the system-on-chip device 922. Moreover, in a particular aspect, as illustrated in FIG. 9, display 928, input device 930, speaker 936, microphone 938, wireless antenna 942, and power supply 944 can be coupled to a component of the system-on-chip device 922, such as an interface or a controller.

In one aspect, the processor memory 906 or the external memory 910, or both, may be configured as a non-transitory computer-readable medium comprising program code that includes instructions, which, when read and executed by a processor, such as the processor 902, cause the computing device 900 to perform any of the operations discussed herein, such as adding entries to BF data structure 912, rotating bloom filters of the BF data structure 912, clearing bloom filters of the BF data structure 912, and/or searching the BF data structure 912 for candidate entries (e.g., transactions corresponding to TLB entries of TLB 914).

It should also be noted that although FIG. 9 depicts a computing device 900, processor 902, including the MMU 904 with BF data structure 912, may also be integrated into a wireless device, a set-top box, a music player, a video player, an entertainment unit, a navigation device, a personal digital assistant (PDA), a fixed location data unit, a server, a computer, a laptop, a tablet, a mobile phone, or other similar devices. These devices may or may not include wireless communication capabilities.

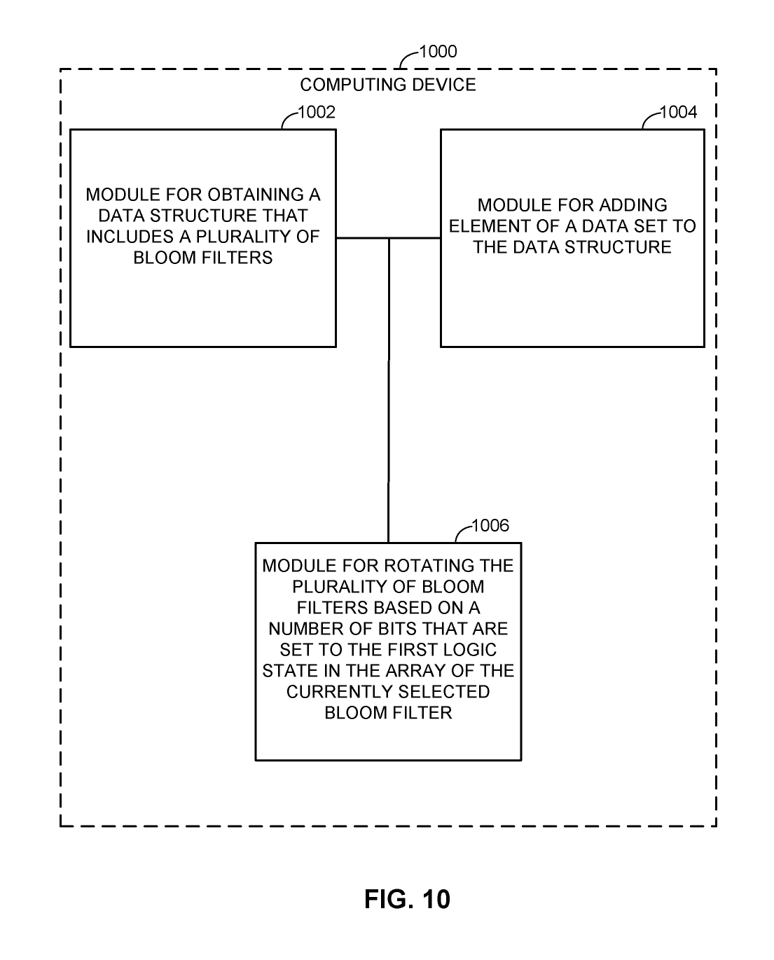

FIG. 10 illustrates several sample aspects of components that may be employed in a computing device 1000, according to various aspects. Computing device 1000 is one possible implementation of computing device 900 of FIG. 9. Alternatively, computing device 1000 may be any device incorporating the data structure 200 of FIG. 2, and/or the functionality described with reference to any of the processes described in FIGS. 1-8.

A module 1002 for obtaining a data structure that includes a plurality of bloom filters may correspond at least in some aspects to, for example, data structure 200 of FIG. 2, MMU 702 of FIG. 7, and/or processor 902 of FIG. 9. A module 1004 for adding an element of a data set to the data structure may correspond at least in some aspects to, for example, fill unit 724 of FIG. 7 and/or processor 902 of FIG. 9. A module 1006 for rotating the plurality of bloom filters based on a number of bits that are set to the first logic state in the array of the currently selected bloom filter may correspond at least in some aspects to, for example, rotate unit 726 of FIG. 7, and/or processor 902 of FIG. 9.

The functionality of the modules 1002-1006 may be implemented in various ways consistent with the teachings herein. In some designs, the functionality of modules 1002-1006 may be implemented as one or more electrical components. In some designs, the functionality of modules 1002-1006 may be implemented as a processing system including one or more processor components. In some designs, the functionality of modules 1002-1006 may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIG. 10, as well as other components and functions described herein, may be implemented using any suitable means. Such means also may be implemented, at least in part, using corresponding structure as taught herein. For example, the components described above in conjunction with the “module for” components of FIG. 10 also may correspond to similarly designated “means for” functionality. Thus, in some aspects, one or more of such means may be implemented using one or more of processor components, integrated circuits, or other suitable structure as taught herein.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an implementation or practice according to one or more aspects can include a computer-readable media embodying a method for dynamically tunable signature-based of speculative optimizations based on instruction signature, according to various aspects. Accordingly, the practices are not limited to illustrated examples. Instead, any means for performing the functionality described herein are included in the scope of practices and implementations contemplated by this disclosure.

While the foregoing disclosure shows illustrative implementations or practice according to one or more aspects, it should be noted that various changes and modifications could be made herein without departing from the scope of implementations, configurations, arrangements or practices according to one or more aspects, defined by the appended claims. The functions, steps and/or actions of the method claims in accordance with the concepts and aspects described herein need not be performed in any particular order. Furthermore, although elements of implementations, configurations, arrangements or practices according to one or more aspects may be described or claimed in the singular, the plural is contemplated unless limitation to the singular is explicitly stated.

What is claimed is:

1. A method, comprising:
obtaining, by a processor, a data structure that includes a plurality of bloom filters, wherein:
each bloom filter of the plurality of bloom filters includes an array of bits,
each bloom filter of the plurality of bloom filters is associated with a plurality of hash functions, and
each hash function of the plurality of hash functions maps at least one element of a data set to at least one of the bits of the array;
adding, by the processor, an element of the data set to the data structure, wherein adding the element to the data structure includes:
determining a currently selected bloom filter of the plurality of bloom filters,
applying the element of the data set to each of the plurality of hash functions of the currently selected bloom filter to obtain a corresponding plurality of array bit positions of the array of the currently selected bloom filter, and
setting bits of the array of the currently selected bloom filter at each of the plurality of array bit positions to a first logic state; and
rotating, by the processor, the plurality of bloom filters based on a number of bits that are set to the first logic state in the array of the currently selected bloom filter, wherein rotating the plurality of bloom filters includes selecting a next bloom filter of the plurality of bloom filters as the currently selected bloom filter.

2. The method of claim 1, further comprising:
estimating a number of elements stored in the currently selected bloom filter based on the number of bits that are set to the first logic state in the array of the currently selected bloom filter, wherein rotating the plurality of bloom filters is based on the number of elements stored in the currently selected bloom filter.

3. The method of claim 2, further comprising:
determining whether the number of elements stored in the currently selected bloom filter is greater than a fill threshold, wherein rotating the plurality of bloom filters is in response to determining that the number of elements stored in the currently selected bloom filter is greater than the fill threshold.

4. The method of claim 3, wherein estimating the number of elements stored in the currently selected bloom filter is based, in part, on a total number of bits in the array of the currently selected bloom filter, a number of the hash functions included in the plurality of hash functions associated with the currently selected bloom filter, and the number of bits that are set to the first logic state in the array of the currently selected bloom filter.

5. The method of claim 4, wherein estimating the number of elements stored in the currently selected bloom filter is based on:
$$E = - \frac{m}{k} ln [ 1 - \frac{\# of Set Bits}{m} ] ,$$
where E is the number of elements stored in the currently selected bloom filter, m is the total number of bits in the array of the currently selected bloom filter, k is the number of the hash functions included in the plurality of hash functions associated with the currently selected bloom filter, and # of Set Bits is the number of bits that are set to the first logic state in the array of the currently selected bloom filter.

6. The method of claim 3, wherein the fill threshold is based on a maximum history of the data structure and a number of bloom filters included in the plurality of bloom filters.

7. The method of claim 6, wherein the fill threshold is based on a ratio n/N, where n is the maximum history of the data structure and N is the number of bloom filters included in the plurality of bloom filters.

8. The method of claim 1, wherein rotating the plurality of bloom filters is in response to determining that the number of bits that are set to the first logic state in the array of the currently selected bloom filter is greater than a set bit threshold.

9. The method of claim 1, further comprising:
searching each bloom filter of the plurality of bloom filters for a candidate element; and
determining that the candidate element is in the data set in response to any of the plurality of bloom filters indicating that the candidate element is in the data set.

10. The method of claim 1, wherein rotating the plurality of bloom filters further includes clearing the next bloom filter before selecting the next bloom filter as the currently selected bloom filter.

11. The method of claim 1, further comprising:
determining a false hit rate of the data structure; and
clearing each bloom filter of the plurality of bloom filters in response to determining that the false hit rate exceeds a false hit rate threshold.

12. The method of claim 1, wherein the data set comprises one or more translation lookaside buffer (TLB) entries stored in a TLB of the processor, the method further comprising:
receiving a first virtual address and one or more subsequent virtual addresses, wherein the one or more subsequent virtual addresses are similar to the first virtual address;
searching the data structure, including the plurality of bloom filters, to determine whether a TLB entry corresponding to the first virtual address is stored in the TLB;
stacking the subsequent virtual addresses in response to determining that there is no TLB entry corresponding to the first virtual address stored in the TLB, wherein stacking the subsequent virtual addresses includes delaying translation of the subsequent virtual addresses until a translation of the first virtual address is complete and the TLB entry corresponding to the first virtual address is stored in the TLB; and
initiating translation of the subsequent virtual addresses without stacking and without the delay in response to determining that there is a TLB entry corresponding to the first virtual address stored in the TLB.

13. The method of claim 12, further comprising determining that the one or more subsequent virtual addresses are similar to the first virtual address in response to determining that the one or more subsequent virtual addresses and the first virtual address are included in a same page of virtual address space.

14. A computing device, comprising:
at least one processor; and
at least one memory coupled to the at least one processor, the at least one processor and the at least one memory being configured to direct the computing device to:
obtain a data structure that includes a plurality of bloom filters, wherein:
each bloom filter of the plurality of bloom filters includes an array of bits,
each bloom filter of the plurality of bloom filters is associated with a plurality of hash functions, and
each hash function of the plurality of hash functions maps at least one element of a data set to at least one of the bits of the array;
add an element of the data set to the data structure, wherein adding the element to the data structure includes:
determining a currently selected bloom filter of the plurality of bloom filters,
applying the element of the data set to each of the plurality of hash functions of the currently selected bloom filter to obtain a corresponding plurality of array bit positions of the array of the currently selected bloom filter, and
setting each of the plurality of array bit positions to a first logic state; and
rotate the plurality of bloom filters based on a number of bits that are set to the first logic state in the array of the currently selected bloom filter, wherein rotating the plurality of bloom filters includes selecting a next bloom filter of the plurality of bloom filters as the currently selected bloom filter.

15. The computing device of claim 14, wherein the at least one processor and the at least one memory are further configured to direct the computing device to:
estimate a number of elements stored in the currently selected bloom filter based on the number of bits that are set to the first logic state in the array of the currently selected bloom filter, wherein rotating the plurality of bloom filters is in response to determining that the number of elements stored in the currently selected bloom filter is greater than a fill threshold.

16. The computing device of claim 15, wherein the at least one processor and the at least one memory are further configured to direct the computing device to:
estimate the number of elements stored in the currently selected bloom filter based, in part, on a total number of bits in the array of the currently selected bloom filter, a number of the hash functions included in the plurality of hash functions associated with the currently selected bloom filter, and the number of bits that are set to the first logic state in the array of the currently selected bloom filter.

17. The computing device of claim 15, wherein the at least one processor and the at least one memory are further configured to direct the computing device to estimate the number of elements stored in the currently selected bloom filter is based on:
$$E = - \frac{m}{k} ln [ 1 - \frac{\# of Set Bits}{m} ] ,$$
where E is the number of elements stored in the currently selected bloom filter, m is the total number of bits in the array of the currently selected bloom filter, k is the number of the hash functions included in the plurality of hash functions associated with the currently selected bloom filter, and # of Set Bits is the number of bits that are set to the first logic state in the array of the currently selected bloom filter.

18. The computing device of claim 15, wherein the fill threshold is based on a ratio n/N, where n is a maximum history of the data structure and N is a number of bloom filters included in the plurality of bloom filters.

19. The computing device of claim 14, wherein the at least one processor and the at least one memory are further configured to direct the computing device to rotate the plurality of bloom filters is in response to determining that the number of bits that are set to the first logic state in the array of the currently selected bloom filter is greater than a set bit threshold.

20. The computing device of claim 14, wherein the at least one processor and the at least one memory are further configured to direct the computing device to:
search each bloom filter of the plurality of bloom filters for a candidate element; and
determine that the candidate element is in the data set in response to any of the plurality of bloom filters indicating that the candidate element is in the data set.

21. The computing device of claim 14, wherein the at least one processor and the at least one memory are further configured to direct the computing device to clear the next bloom filter before selecting the next bloom filter as the currently selected bloom filter.

22. The computing device of claim 14, wherein the at least one processor and the at least one memory are further configured to direct the computing device to:
determine a false hit rate of the data structure; and
clear each bloom filter of the plurality of bloom filters in response to determining that the false hit rate exceeds a false hit rate threshold.

23. The computing device of claim 14, further comprising:
a translation lookaside buffer (TLB) of the at least one processor, wherein the data set includes one or more TLB entries stored in the TLB, the at least one processor and at least one memory further configured to direct the computing device to:
receive a first virtual address and one or more subsequent virtual addresses, wherein the one or more subsequent virtual addresses are similar to the first virtual address;
search the data structure, including the plurality of bloom filters, to determine whether a TLB entry corresponding to the first virtual address is stored in the TLB;
stack the subsequent virtual addresses in response to determining that there is no TLB entry corresponding to the first virtual address stored in the TLB, wherein stacking the subsequent virtual addresses includes delaying translation of the subsequent virtual addresses until a translation of the first virtual address is complete and the TLB entry corresponding to the first virtual address is stored in the TLB; and
initiate translation of the subsequent virtual addresses without stacking and without the delay in response to determining that there is a TLB entry corresponding to the first virtual address stored in the TLB.

24. The computing device of claim 23, wherein the at least one processor and the at least one memory are further configured to direct the computing device to determine that the one or more subsequent virtual addresses are similar to the first virtual address in response to determining that the one or more subsequent virtual addresses and the first virtual address are included in a same page of virtual address space.

25. A computing device, comprising:
means for obtaining a data structure that includes a plurality of bloom filters, wherein:
each bloom filter of the plurality of bloom filters includes an array of bits,
each bloom filter of the plurality of bloom filters is associated with a plurality of hash functions, and
each hash function of the plurality of hash functions maps at least one element of a data set to at least one of the bits of the array;
means for adding an element of the data set to the data structure, wherein the means for adding the element to the data structure includes:
means for determining a currently selected bloom filter of the plurality of bloom filters,
means for applying the element of the data set to each of the plurality of hash functions of the currently selected bloom filter to obtain a corresponding plurality of array bit positions of the array of the currently selected bloom filter, and
means for setting each of the plurality of array bit positions to a first logic state; and
means for rotating the plurality of bloom filters based on a number of bits that are set to the first logic state in the array of the currently selected bloom filter, wherein the means for rotating the plurality of bloom filters includes means for selecting a next bloom filter of the plurality of bloom filters as the currently selected bloom filter.

26. The computing device of claim 25, further comprising:
means for estimating a number of elements stored in the currently selected bloom filter based, in part, on a total number of bits in the array of the currently selected bloom filter, a number of the hash functions included in the plurality of hash functions associated with the currently selected bloom filter, and the number of bits that are set to the first logic state in the array of the currently selected bloom filter, wherein the means for rotating the plurality of bloom filters includes means for rotating the plurality of bloom filters in response to a determination that the number of elements stored in the currently selected bloom filter is greater than a fill threshold.

27. The computing device of claim 26, wherein the fill threshold is based on a ratio n/N, where n is a maximum history of the data structure and N is a number of bloom filters included in the plurality of bloom filters.

28. The computing device of claim 26, further comprising:
at least one processor that includes a translation lookaside buffer (TLB), wherein the data set includes one or more TLB entries stored in the TLB;
means for receiving a first virtual address and one or more subsequent virtual addresses, wherein the one or more subsequent virtual addresses are similar to the first virtual address;
means for searching the data structure, including the plurality of bloom filters, to determine whether a TLB entry corresponding to the first virtual address is stored in the TLB;
means for stacking the subsequent virtual addresses in response to determining that there is no TLB entry corresponding to the first virtual address stored in the TLB, wherein stacking the subsequent virtual addresses includes delaying translation of the subsequent virtual addresses until a translation of the first virtual address is complete and the TLB entry corresponding to the first virtual address is stored in the TLB; and
means for initiating translation of the subsequent virtual addresses without stacking and without the delay in response to determining that there is a TLB entry corresponding to the first virtual address stored in the TLB.

29. A non-transitory computer-readable medium including program code stored thereon, wherein the program code includes instructions, which when executed by a processor of a computing device, direct the computing device to:
obtain a data structure that includes a plurality of bloom filters, wherein:
each bloom filter of the plurality of bloom filters includes an array of bits,
each bloom filter of the plurality of bloom filters is associated with a plurality of hash functions, and
each hash function of the plurality of hash functions maps at least one element of a data set to at least one of the bits of the array;
add an element of the data set to the data structure, wherein adding the element to the data structure includes:
determining a currently selected bloom filter of the plurality of bloom filters,
applying the element of the data set to each of the plurality of hash functions of the currently selected bloom filter to obtain a corresponding plurality of array bit positions of the array of the currently selected bloom filter, and
setting each of the plurality of array bit positions to a first logic state; and
rotate the plurality of bloom filters based on a number of bits that are set to the first logic state in the array of the currently selected bloom filter, wherein the instructions to rotate the plurality of bloom filters includes instructions to select a next bloom filter of the plurality of bloom filters as the currently selected bloom filter.

30. The non-transitory computer-readable medium of claim 29, wherein the program code further includes instructions to direct the computing device to:
estimate a number of elements stored in the currently selected bloom filter based, in part, on a total number of bits in the array of the currently selected bloom filter, a number of the hash functions included in the plurality of hash functions associated with the currently selected bloom filter, and the number of bits that are set to the first logic state in the array of the currently selected bloom filter, wherein the instructions to rotate the plurality of bloom filters includes instructions to rotate the plurality of bloom filters in response to a determination that the number of elements stored in the currently selected bloom filter is greater than a fill threshold.

31. The non-transitory computer-readable medium of claim 30 wherein the fill threshold is based on a ratio n/N, where n is a maximum history of the data structure and N is a number of bloom filters included in the plurality of bloom filters.

32. The non-transitory computer-readable medium of claim 31, wherein the data set includes one or more TLB entries stored in a translation lookaside buffer (TLB) of at least one processor of the computing device, wherein the program code further includes instruction to direct the computing device to:
receive a first virtual address and one or more subsequent virtual addresses at the TLB, wherein the one or more subsequent virtual addresses are similar to the first virtual address;
search the data structure, including the plurality of bloom filters, to determine whether a TLB entry corresponding to the first virtual address is stored in the TLB;
stack the subsequent virtual addresses in response to determining that there is no TLB entry corresponding to the first virtual address stored in the TLB, wherein stacking the subsequent virtual addresses includes delaying translation of the subsequent virtual addresses until a translation of the first virtual address is complete and the TLB entry corresponding to the first virtual address is stored in the TLB; and
initiate translation of the subsequent virtual addresses without stacking and without the delay in response to determining that there is a TLB entry corresponding to the first virtual address stored in the TLB.
